(19) United States
(12) Patent Application Publication
(10) Pub. No.: US 2014/0235274 A1
(43) Pub. Date: Aug. 21, 2014

(54) HANDHELD IMPACT NOTIFICATION AND AVOIDANCE SYSTEM

(71) Applicant: TIMES THREE WIRELESS INC., Calgary (CA)

(72) Inventors: Michael Hryciuk, Calgary (CA); Andrew Borsodi, Calgary (CA)

(73) Assignee: TIMES THREE WIRELESS INC., Calgary (CA)

(21) Appl. No.: 13/769,264

(22) Filed: Feb. 15, 2013

(51) Int. Cl. H04W 4/02

(52) U.S. Cl. CPC H04W 4/027
USPC 455/456.3

(57) ABSTRACT

In some implementations, a handheld mobile device detects possible impact with or from another object, and in response, provides notice of the possible impact and provides information on evasive action to avoid the impact.

### FIELD

This disclosure relates generally to impact avoidance by a mobile device, and more particularly to impact avoidance between a mobile device and other objects.

### BACKGROUND

Mobile devices provide notification of when the mobile device is in range of a cell phone tower the signal strength of a signal from the cell phone tower. Mobile devices also provide information on the locale and the landmark(s) in the vicinity of the mobile device.

### BRIEF DESCRIPTION

The subject matter of this disclosure includes an impact avoidance system in handheld mobile device to notify an operator of the handheld mobile device of an imminent impact with another object. In one implementation of the subject matter, the impact avoidance system notifies the operator of the handheld mobile device of the imminent impact which would require the operator to immediately focus his/her attention on their immediate surroundings and take impact avoidance actions. In the case of an imminent impact with a stationary object the simplest action may be to stop moving but in the case of an impending impact with a moving object this may require the operator to execute an avoidance maneuver. In a second embodiment of the subject matter the system would display the best recommended impact avoidance action to be taken by the operator.

In one aspect, a method of a handheld mobile device includes receiving internal motion data that represents a direction and a speed of the handheld mobile device, receiving external motion data that represents a direction and a speed of an external object, determining a relative motion of the handheld mobile device and the external object from the data that represents the direction and the speed of the handheld mobile device and the data that represents the direction and the speed of external object, determining a risk of an impact between the handheld mobile device and the external object in an immediate vicinity from the relative motion of the handheld mobile device and the external object, and changing output of the handheld device when the risk of the impact between the handheld mobile device and the external object in the immediate vicinity is greater than a predetermined threshold.

In another aspect, a handheld mobile device includes a determiner of a relative motion of the handheld mobile device and an external object from data that represents a direction and a speed of the handheld mobile device and from data that represents a direction and a speed of the external object, a receiver of internal motion data that represents the direction and the speed of the handheld mobile device, the receiver being operably coupled to the determiner, a receiver of external motion data that represents the direction and the speed of the external object, the receiver being operably coupled to the determiner, a determiner a risk of an impact between the handheld mobile device and an object in an immediate vicinity from the relative motion of the handheld mobile device and the external object, and a changer of output of the handheld device when the risk of the impact between the handheld mobile device and the external object in the immediate vicinity is greater than a predetermined threshold.

In yet another aspect, an apparatus in a handheld mobile device includes a determiner of a relative motion of the handheld mobile device and an external object from data that represents a direction and a speed of the handheld mobile device and from data that represents a direction and a speed of the external object, a receiver of internal motion data that represents the direction and the speed of the handheld mobile device, the receiver being operably coupled to the determiner, a receiver of external motion data that represents the direction of the external object and the speed of the external object, the receiver being operably coupled to the determiner, a determiner a risk of an impact between the handheld mobile device and the external object in an immediate vicinity from the relative motion of the handheld mobile device and the external object, and a changer of output of the handheld device when the risk of the impact between the handheld mobile device and the external object in the immediate vicinity is greater than a predetermined threshold.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to provide impact avoidance notification, according to an implementation;

FIG. 2 is a block diagram of an overview of apparatus to provide impact avoidance notification, according to an implementation;

FIG. 3 is a flowchart of a method of a handheld mobile device, according to an implementation;

FIG. 4 is a flowchart of a method of a handheld mobile device, according to an implementation;

FIG. 5 is a flowchart of a method of a handheld mobile device, according to an implementation;

FIG. 6 is a flowchart of a method of a handheld mobile device, according to an implementation;

FIG. 7 is a flowchart of a method of a handheld mobile device to determine collisions between the stationary objects and either the handheld mobile device or the operator of the handheld mobile device, according to an implementation;

FIG. 8 is a block diagram of a mobile device, according to an implementation;

FIG. 9 is a block diagram of a communication subsystem component of the mobile device of FIG. 8, according to an implementation;

FIG. 10 is a block diagram of an exemplary implementation of a node of the wireless network; and

FIG. 11 is a block diagram illustrating components of a host system for use with the wireless network of FIG. 10 and the mobile device of FIG. 8, according to an implementation.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, implementations of apparatus are described. In the third section, methods are described. In the fourth section, hardware and the operating environments in conjunction with which implementations may be practiced are described. In the fifth section, a conclusion of the detailed description is provided.

### System Level Overview

The system level overview of the operation of an implementation is described in this section of the detailed description.

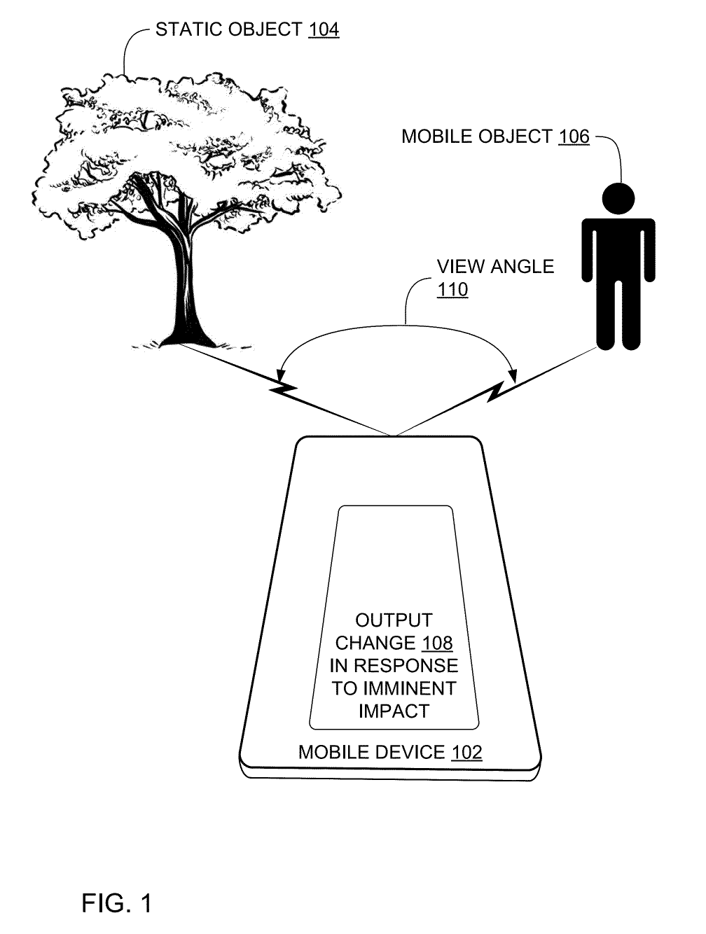

FIG. 1 is a block diagram of an overview of a system 100 to provide impact avoidance notification, according to an implementation.

System 100 includes a handheld mobile device 102 that is operable to access heterogeneous wireless networks such as a Wi-Fi access point or a 3G/4G network that is operated by a 3G/4G mobile operator. The 3G/4G network is a wireless network that operates in both 3G and 4G protocols. In some implementations, the Wi-Fi access point is operated by a retail commercial establishment such as a coffee shop.

Handheld mobile device 102 provides notification of an imminent impact between the handheld mobile device 102 or the operator of the handheld mobile device 102 and an object such as a stationary object 104 or a mobile object 106. In some implementations the notification is a change in the output 108 in response to a possible impact between the handheld mobile device 102 or the operator of the handheld mobile device 102 and the object. The change in the output 108 is a change from what was previously output from the handheld mobile device before detection of the imminent impact. In one implementation, the change in the output 108 is not what would have been displayed on the display in the absence the detection of the imminent impact. Some implementations, the change of the display 108 is a blank display. In other implementations of the change of the display 108 is a visual display notification of the imminent impact. The change of the display 108 provides notification of the imminent impact.

The handheld mobile device 102 detects the stationary object 104 or the mobile object 106 through a view angle 110, such as the view angle 110 of about 135 degrees as shown in FIG. 1 that is notably wider than view angles on conventional automobile collision detectors. The wider view angle detects imminent impact from mobile objects 106 that are to the side of or directly in front of the handheld mobile device 102. In other implementations, the view angle 110 is narrower, such as 90 degrees, and in other implementations, the view angle 110 is wider, such as 270 degrees.

In some implementations, the notification of the imminent impact is a change in the audio output of the handheld mobile device 102 in response to a possible impact between the handheld mobile device 102 or the operator of the handheld mobile device 102 and the object. The change in the audio output 110 is a change from what was previously output from an audio module of the handheld mobile device 102 before detection of the imminent impact. The change in the audio output is not what would have been output from the audio module in the absence the detection of the imminent impact. Some implementations, the notification of the imminent impact is a change in the display output of the handheld mobile device 102, which in one example is a blank display. The benefit of the blank display is that the blank display reduces the distraction of the activity on the display. In other implementations of the change of the display output is a visual display notification of the imminent impact.

System 100 helps prevent impacts between operators of handheld mobile devices and other objects such as stationary objects or moving objects, including but not limited to pedestrians and other operators of mobile devices caused by the operator not being aware of his/her immediate surroundings and prevents the operator of the handheld mobile device 102 from being struck by moving objects including but not limited to pedestrians and other operators of mobile devices caused by the operator not being aware of his/her immediate surroundings. These impacts may cause personal injury or damage to personal property. System 100 also obviates the expense of lanes of walkways (similar to lanes on a motor vehicle roadway) to assist in the reduction of impacts. System 100 also obviates the expense of an omnidirectional mirror or an omnidirectional video camera that allow the operator of the handheld mobile device 102 to see objects in his/her immediate vicinity. System 100 also does not require the operator of a handheld mobile device 102 to devote some fraction of their attention to the mirror or video display and to manually asses the risk of an impact and manually determine suitable avoidance maneuvers.

### Apparatus

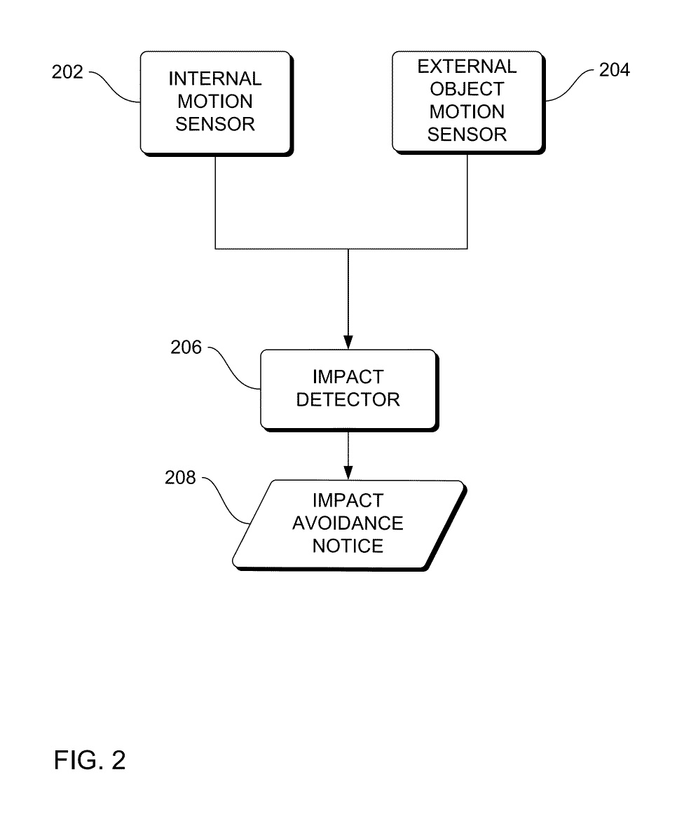

FIG. 2 is a block diagram of an overview of apparatus 200 to provide impact avoidance notification, according to an implementation. Apparatus 200 is located within a handheld mobile device, such as handheld mobile device 102 in FIG. 1.

Apparatus 200 includes an internal motion sensor 202 and an external object motion sensor 204 that are both operably coupled to an impact detector 206. The internal motion sensor 202 detects a direction and speed of movement of the handheld mobile device. The internal motion sensor 202 can include accelerometers, gyroscopes, barometric pressure sensors and GPS tracking devices. The external object motion sensor 204 can include optical sensors, infrared sensors, ultrasonic sensors and RF sensors capable of sensing objects in the immediate vicinity of the operator. The external object motion sensor 204 never includes a radio detection and ranging (RADAR) system or a RADAR antenna because no known RADAR antennae have a form factor that fits in any conventional handheld mobile device. RADAR antennae with a sufficiently narrow beam width in order to be useful, the RADAR would have to be too big to fit on a handheld mobile device. Furthermore, the processing requirements and memory requirements of RADAR is beyond that of conventional handheld mobile devices, particularly when the handheld mobile device 102 is performing a processor intensive application. Thus RADAR is not practical implementation of the external object motion sensor 204 in conventional handheld mobile devices.

The impact detector 206 includes computer executable instructions that are operable to calculate the relative motion between the handheld mobile device and objects in the immediate vicinity for the purpose of determining the risk of an impact between the handheld mobile device and an object in the immediate vicinity. When a risk of impact from an impact exceeds a predetermined level of risk, the impact detector 206 generates an impact avoidance notice 208.

In another implementation, the internal motion sensor 202, the external object motion sensor 204 and the impact detector are replaced with a sensor that detects the relative motion between the user of the handheld mobile device and the external object without actually calculating the actual motion of handheld mobile device and the external object.

Apparatus 200 reduces the risk of impacts between an operator of a handheld mobile device and objects in the immediate vicinity of the handheld mobile device. The apparatus 200 reduces risk of personal impact and risk of damage to personal property (e.g. corrective lenses worn by the operator). Apparatus 200 in a handheld mobile device will increase market share compared to competing handheld mobile devices that do not include this apparatus.

### Method Implementations

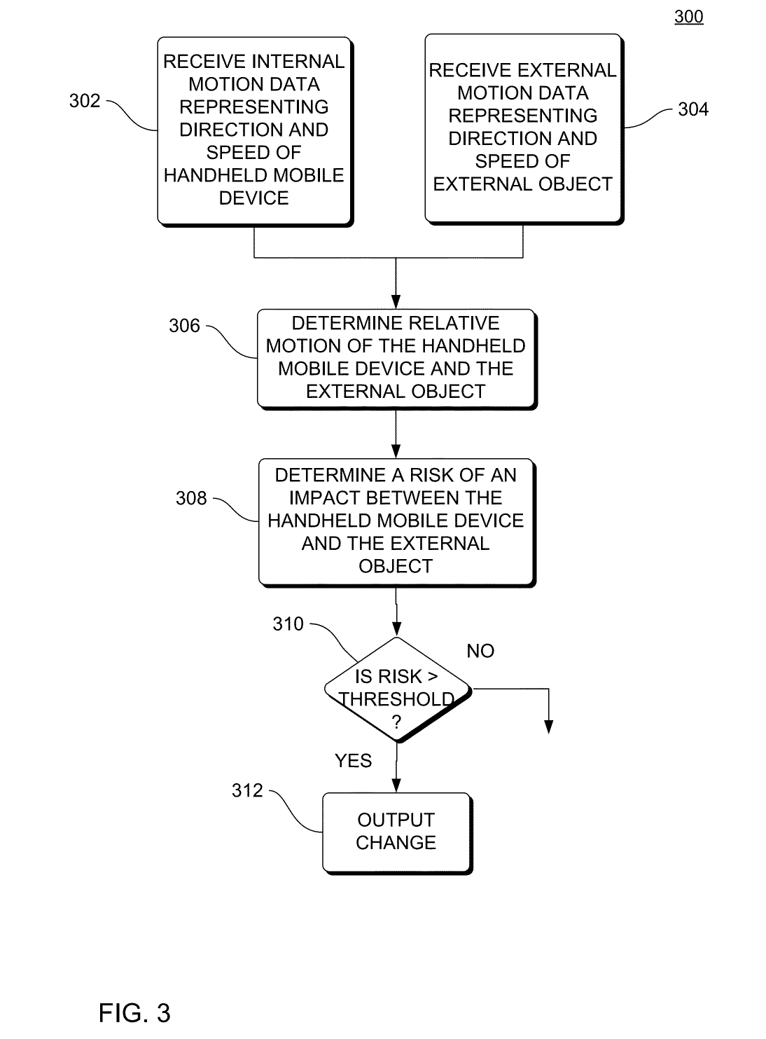

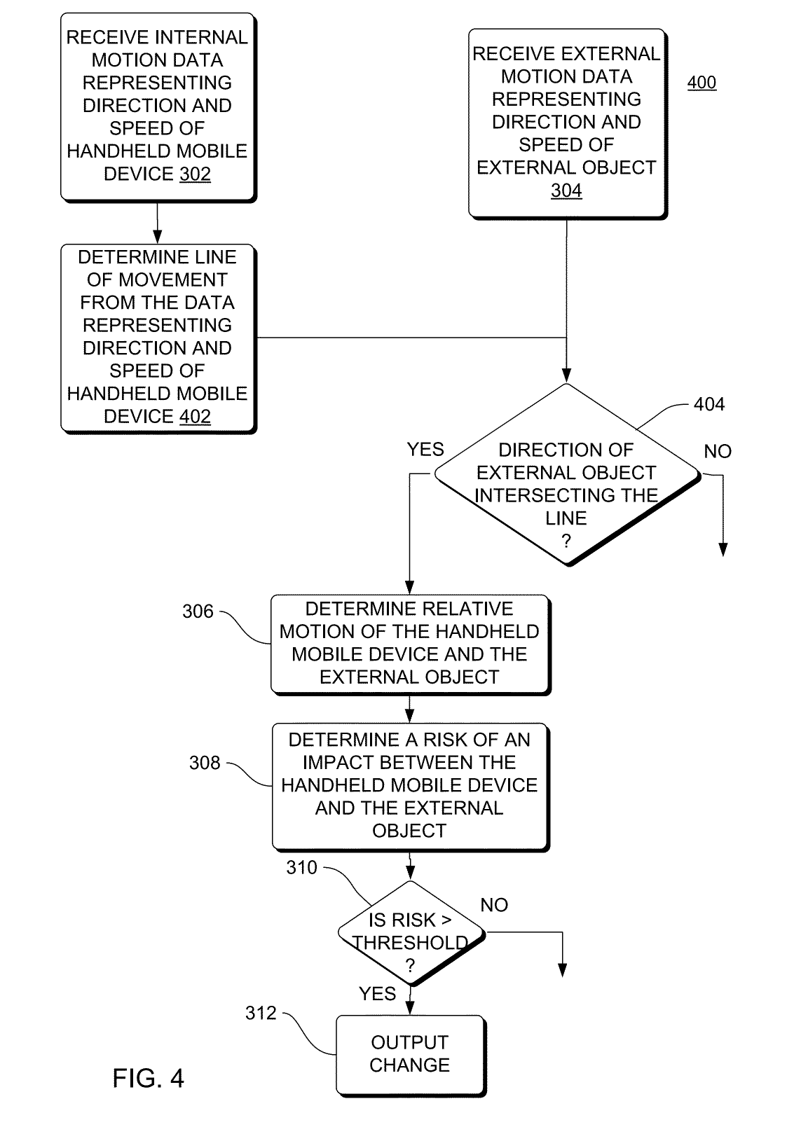

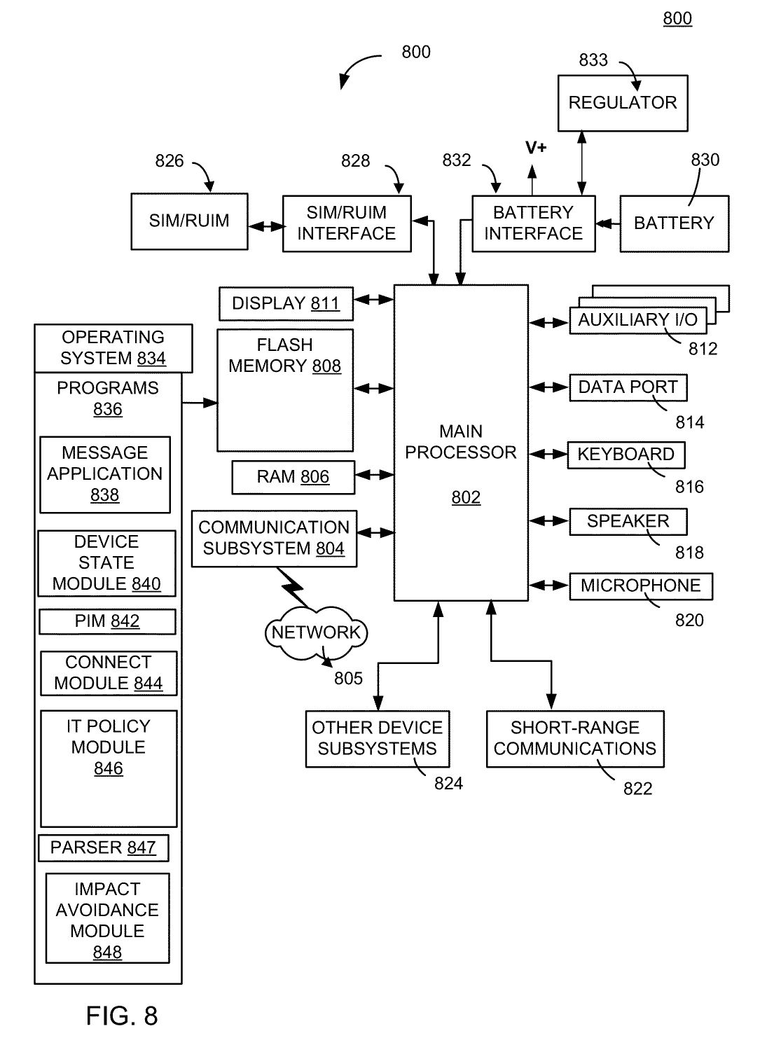

In the previous section, a system level overview of the operation of an implementation is described. In this section, the particular methods of such an implementation are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Method 300-400 are performed by a program executing on, or performed by firmware or hardware that is a part of, a computer, such as handheld mobile device 102 in FIG. 1 and handheld mobile device 800 in FIG. 8. The handheld mobile device is operable to communicate in both a 3G/4G protocol and a Wi-Fi protocol. Handheld mobile device 102 in FIG. 1 and handheld mobile device 800 in FIG. 8 are examples of the handheld mobile device of FIG. 3-4.

FIG. 3 is a flowchart of a method of 300 of a handheld mobile device, according to an implementation.

Method 300 includes the handheld mobile device receiving internal motion data that represents direction and speed of the handheld mobile device, at block 302, and the handheld mobile device receiving external motion data that represents direction and speed of external object, at block 304. The actions of block 302 in 304 can occur in any sequence or simultaneously to each other. Actions 302 and 304 are real-time data gathering operations.

Thereafter, and in response to action 302 and action 304, method 300 includes determining a relative motion of the handheld mobile device and the external object from the data that represents direction and speed of the handheld mobile device and the data that represents direction and speed of external object, at block 306.

Thereafter, method 300 includes determining a risk of an impact between the handheld mobile device and an object in the immediate vicinity from the relative motion of the handheld mobile device and the external object, at block 308.

When the risk of an impact between the handheld mobile device or an operator of the handheld mobile device and an object in the immediate vicinity is greater than a predetermined threshold, at block 310, and in a change in the output of the handheld device is performed, at block 312.

FIG. 4 is a flowchart of a method of 400 of a handheld mobile device, according to an implementation. Method 400 includes the handheld mobile device receiving internal motion data that represents direction and speed of the handheld mobile device, at block 302, and the handheld mobile device receiving external motion data that represents direction and speed of external object, at block 304. The actions of block 302 in 304 can occur in any sequence or simultaneously to each other. Actions 302 and 304 are real-time data gathering operations.

Method 400 also includes determining a plane of movement of the handheld mobile device from the internal motion data that represents the direction and the speed of the handheld mobile device, at block 402. In some implementations, the external motion data that represents the direction and the speed of the external object in a plane that is parallel to the terrain in the vicinity of the handheld mobile device. In some implementations, the plane that is parallel to the terrain is determined by accelerometers. Thereafter a determination of whether or not the plane of movement of the handheld mobile device intersects with the direction of movement of the external object, at block 404. When the direction of movement of the external object does not intersect with the plane of movement of the handheld mobile device or the operator for the handheld mobile device, no further action is taken. Method 400 includes determining a relative motion of the handheld mobile device and the external object from the data that represents direction and speed of the handheld mobile device and the data that represents direction and speed of external object, at block 306, when the direction of movement of the external object is determined to intersect with the plane of movement of the handheld mobile device, at block 404.

Thereafter, method 400 includes determining a risk and severity of an impact between the handheld mobile device or the operator for the handheld mobile device and an object in the immediate vicinity from the relative motion of the handheld mobile device and the external object, at block 308. When the risk of an impact between the handheld mobile device or the operator for the handheld mobile device and an object in the immediate vicinity is greater than a predetermined threshold, at block 310, and in a change in the output of the handheld device is performed, at block 312.

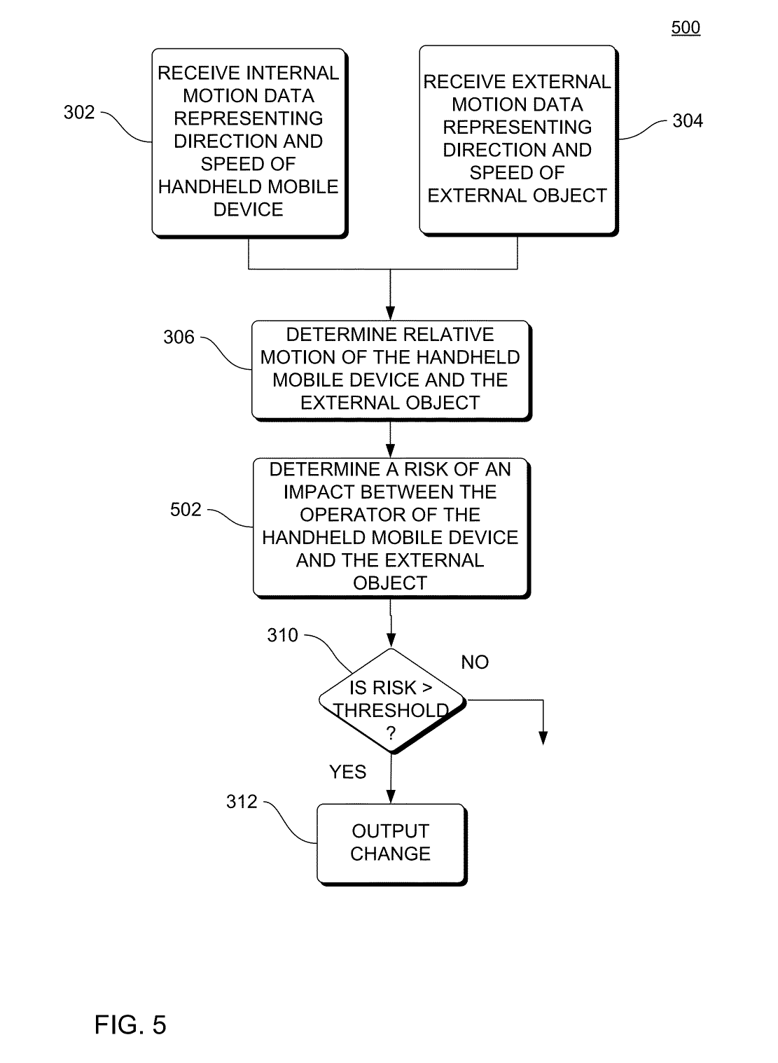

FIG. 5 is a flowchart of a method of 500 of a handheld mobile device, according to an implementation. Method 500 includes the handheld mobile device receiving internal motion data that represents direction and speed of the handheld mobile device, at block 302, and the handheld mobile device receiving external motion data that represents direction and speed of external object, at block 304. The actions of block 302 in 304 can occur in any sequence or simultaneously to each other. Actions 302 and 304 are real-time data gathering operations. Thereafter, and in response to action 302 and action 304, method 500 includes determining a relative motion of the handheld mobile device and the external object from the data that represents direction and speed of the handheld mobile device and the data that represents direction and speed of external object, at block 306.

Thereafter, method 500 includes determining a risk of an impact between the operator of the handheld mobile device and the external object in the immediate vicinity from the relative motion of the handheld mobile device and the external object, at block 502. The determining at block 502 takes into account an expected position of the body of the operator relative to the handheld mobile device, which is typically about 2 feet or 61 cm.

When the risk and severity of an impact between the handheld mobile device and an object in the immediate vicinity is greater than a predetermined threshold, at block 310, and in a change in the output of the handheld device is performed, at block 312.

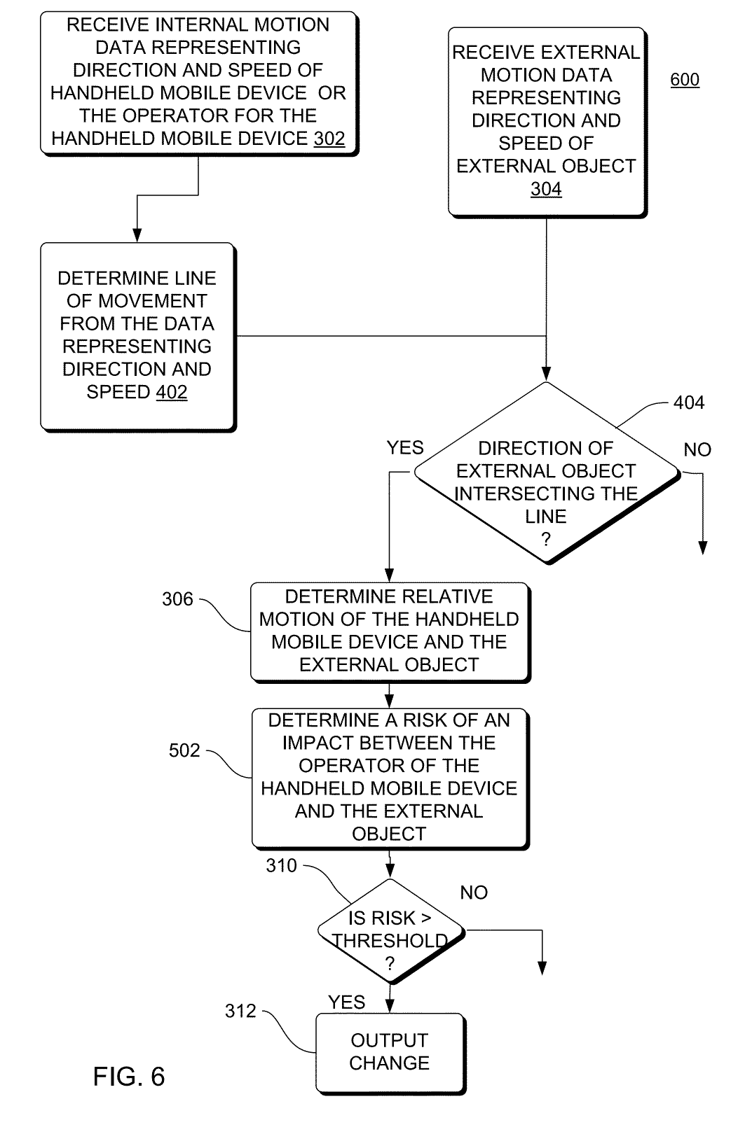

FIG. 6 is a flowchart of a method of 600 of a handheld mobile device, according to an implementation. Method 600 includes the handheld mobile device receiving internal motion data that represents direction and speed of the handheld mobile device, at block 302, and the handheld mobile device receiving external motion data that represents direction and speed of external object, at block 304. The actions of block 302 in 304 can occur in any sequence or simultaneously to each other. Actions 302 and 304 are real-time data gathering operations. Method 600 also includes determining the line of movement of the handheld mobile device or the operator for the handheld mobile device from the internal motion data that represents the direction and the speed of the handheld mobile device, at block 402. Thereafter a determination of whether or not the line of movement of the handheld mobile device or the operator for the handheld mobile device intersects with the direction of movement of the external object. At block 404. When the direction of movement of the external object does not intersect with the line of movement of the handheld mobile device or the operator for the handheld mobile device, no further action is taken. Method 500 includes determining a relative motion of the handheld mobile device or the operator for the handheld mobile device and the external object from the data that represents direction and speed of the handheld mobile device and the data that represents direction and speed of external object, at block 306, when the direction of movement of the external object is determined to intersect with the line of movement of the handheld mobile device or the operator for the handheld mobile device, at block 404.

Thereafter, method 600 includes determining a risk of an impact between the operator of the handheld mobile device and the external object in the immediate vicinity from the relative motion of the handheld mobile device and the external object, at block 502. The determining at block 502 takes into account an expected position of the body of the operator relative to the handheld mobile device, which is typically about 2 feet long and 2 feet wide (or about 6 cm long and 60 cm wide) directly behind the handheld mobile device.

When the risk of an impact between the handheld mobile device and an object in the immediate vicinity is greater than a predetermined threshold, at block 310, and in a change in the output of the handheld device is performed, at block 312.

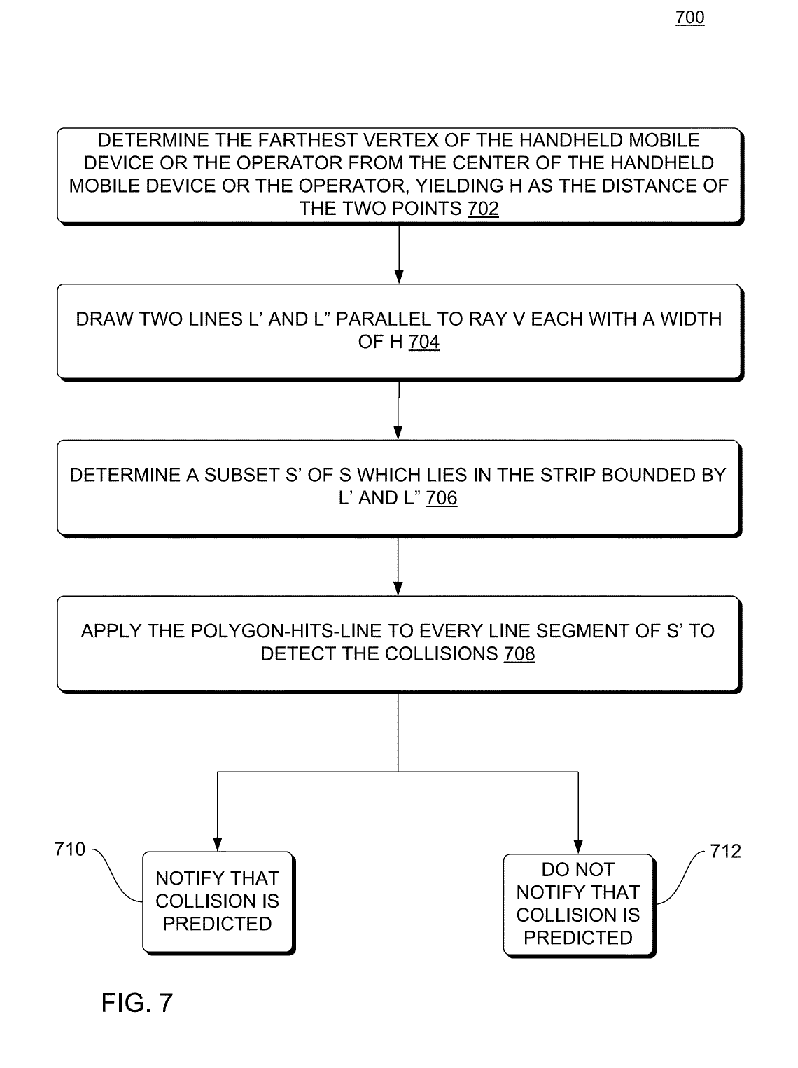

FIG. 7 is a flowchart of a method of 700 of a handheld mobile device to determine collisions between the stationary objects and either the handheld mobile device or the operator of the handheld mobile device, according to an implementation.

In method 700, p represents either the handheld mobile device or the operator of the handheld mobile device having a simple polygon shape and that can be or is rotating around center o (rotating with angular velocity w) and moving towards a set of stationary obstacles S with velocity v (where the velocity includes both the speed and the direction of either the handheld mobile device or the operator of the handheld mobile device) and where S consists of polygons, polygonal chains, points, and S has a total of m vertices. The initial coordinates of p (either the handheld mobile device or the operator of the handheld mobile device) and S (the stationary objects) are also given in a polar coordinate system,

Method 700 determines whether or not a collision will occur between p (either the handheld mobile device or the operator of the handheld mobile device) and if so, with which stationary objects S. Method 700 includes determining the farthest vertex of P (the handheld mobile device or the operator of the handheld mobile device the handheld mobile device or the operator of the handheld mobile device) from 0 (the center of the handheld mobile device or the operator of the handheld mobile device), yielding h as the distance of the two points, at block 702. Method 700 also includes drawing two lines L′ and L″ parallel to ray v each with a width of h, at block 704. Method 700 also includes determining a subset S′ of S which lies in the strip bounded by L′ and L″, at block 706. Method 700 also includes applying Polygon-hits-line to every line segment of S′ to detect the collisions, at block 708. If (a collision is predicted) then report yes and the collided line segment, at block 710; if (S′ is exhausted and no collision is predicted) then report no at block 712.

### Hardware and Operating Environment

FIG. 8-21 are a block diagrams of a hardware and operating environment in which different implementations can be practiced. The descriptions provide an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

The implementations described herein generally relate to a mobile wireless communication device, hereafter referred to as a mobile device, which can be configured according to an IT policy. It should be noted that the term IT policy, in general, refers to a collection of IT policy rules, in which the IT policy rules can be defined as being either grouped or non-grouped and global or per-user. The terms grouped, non-grouped, global and per-user are defined further below. Examples of applicable communication devices include pagers, cellular phones, cellular smart-phones, wireless organizers, personal digital assistants, computers, laptops, handheld wireless communication devices, wirelessly enabled notebook computers and the like.

FIG. 8 is a block diagram of a handheld mobile device 800, according to an implementation. The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

Handheld mobile device 800 is one implementation of handheld mobile device 102 in FIG. 1. The handheld mobile device 800 includes a number of components such as a main processor 802 that controls the overall operation of the handheld mobile device 800. Communication functions, including data and voice communications, are performed through a communication subsystem 804. The communication subsystem 804 receives messages from and sends messages to wireless networks 805. The wireless networks 805 include the 3G/4G network 110 in FIG. 1. In other implementations of the handheld mobile device 800, the communication subsystem 804 can be configured in accordance with the Global System for Mobile Communication (GSM), General Packet Radio Services (GPRS), Enhanced Data GSM Environment (EDGE), Universal Mobile Telecommunications Service (UMTS), data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include Mobitex™ and DataTAC™ network communication systems. Examples of other voice-centric data networks include Personal Communication Systems (PCS) networks like GSM and Time Division Multiple Access (TDMA) systems.

The wireless link connecting the communication subsystem 804 with the wireless network 805 represents one or more different Radio Frequency (RF) channels. With newer network protocols, these channels are capable of supporting both circuit switched voice communications and packet switched data communications.

The main processor 802 also interacts with additional subsystems such as a Random Access Memory (RAM) 806, a flash memory 808, a display 810, an auxiliary input/output (I/O) subsystem 812, a data port 814, a keyboard 816, a speaker 818, a microphone 820, short-range communications 822 and other device subsystems 824. The speaker 818 is an element of the audio module discussed in conjunction with FIG. 1. The audio module also includes a headphone jack (not shown in FIG. 8).

Some of the subsystems of the handheld mobile device 800 perform communication-related functions, whereas other subsystems may provide “resident” or on-device functions. By way of example, the display 810 and the keyboard 816 may be used for both communication-related functions, such as entering a text message for transmission over the wireless network 805, and device-resident functions such as a calculator or task list.

The handheld mobile device 800 can transmit and receive communication signals over the wireless network 805 after required network registration or activation procedures have been completed. Network access is associated with a subscriber or user of the handheld mobile device 800. To identify a subscriber, the handheld mobile device 800 requires a SIM/RUIM card 826 (i.e. Subscriber Identity Module or a Removable User Identity Module) to be inserted into a SIM/RUIM interface 828 in order to communicate with a network. The SIM card or RUIM 826 is one type of a conventional “smart card” that can be used to identify a subscriber of the handheld mobile device 800 and to personalize the handheld mobile device 800, among other things. Without the SIM card 826, the handheld mobile device 800 is not fully operational for communication with the wireless network 805. By inserting the SIM card/RUIM 826 into the SIM/RUIM interface 828, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 826 includes a processor and memory for storing information. Once the SIM card/RUIM 826 is inserted into the SIM/RUIM interface 828, it is coupled to the main processor 802. In order to identify the subscriber, the SIM card/RUIM 826 can include some user parameters such as an International Mobile Subscriber Identity (IMSI). An advantage of using the SIM card/RUIM 826 is that a subscriber is not necessarily bound by any single physical mobile device. The SIM card/RUIM 826 may store additional subscriber information for a mobile device as well, including datebook (or calendar) information and recent call information. Alternatively, user identification information can also be programmed into the flash memory 808.

The handheld mobile device 800 is a battery-powered device and includes a battery interface 832 for receiving one or more rechargeable batteries 830. In one or more implementations, the battery 830 can be a smart battery with an embedded microprocessor. The battery interface 832 is coupled to a regulator 833, which assists the battery 830 in providing power V+ to the handheld mobile device 800. Although current technology makes use of a battery, future technologies such as micro fuel cells may provide the power to the handheld mobile device 800.

The handheld mobile device 800 also includes an operating system 834 and software components 836 to 848 which are described in more detail below. The operating system 834 and the software components 836 to 848 that are executed by the main processor 802 are typically stored in a persistent store such as the flash memory 808, which may alternatively be a read-only memory (ROM) or similar storage element (not shown). Those skilled in the art will appreciate that portions of the operating system 834 and the software components 836 to 848, such as specific device applications, or parts thereof, may be temporarily loaded into a volatile store such as the RAM 806. Other software components can also be included.

The subset of software applications 836 that control basic device operations, including data and voice communication applications, will normally be installed on the handheld mobile device 800 during its manufacture. Other software applications include a message application 838 that can be any suitable software program that allows a user of the handheld mobile device 800 to transmit and receive electronic messages. Various alternatives exist for the message application 838 as is well known to those skilled in the art. Messages that have been sent or received by the user are typically stored in the flash memory 808 of the handheld mobile device 800 or some other suitable storage element in the handheld mobile device 800. In one or more implementations, some of the sent and received messages may be stored remotely from the device 800 such as in a data store of an associated host system with which the handheld mobile device 800 communicates.

The software applications can further include a device state module 840, a Personal Information Manager (PIM) 842, and other suitable modules (not shown). The device state module 840 provides persistence, i.e. the device state module 840 ensures that important device data is stored in persistent memory, such as the flash memory 808, so that the data is not lost when the handheld mobile device 800 is turned off or loses power.

The PIM 842 includes functionality for organizing and managing data items of interest to the user, such as, but not limited to, e-mail, contacts, calendar events, voice mails, appointments, and task items. A PIM application has the ability to transmit and receive data items via the wireless network 805. PIM data items may be seamlessly integrated, synchronized, and updated via the wireless network 805 with the mobile device subscriber's corresponding data items stored and/or associated with a host computer system. This functionality creates a mirrored host computer on the handheld mobile device 800 with respect to such items. This can be particularly advantageous when the host computer system is the mobile device subscriber's office computer system.

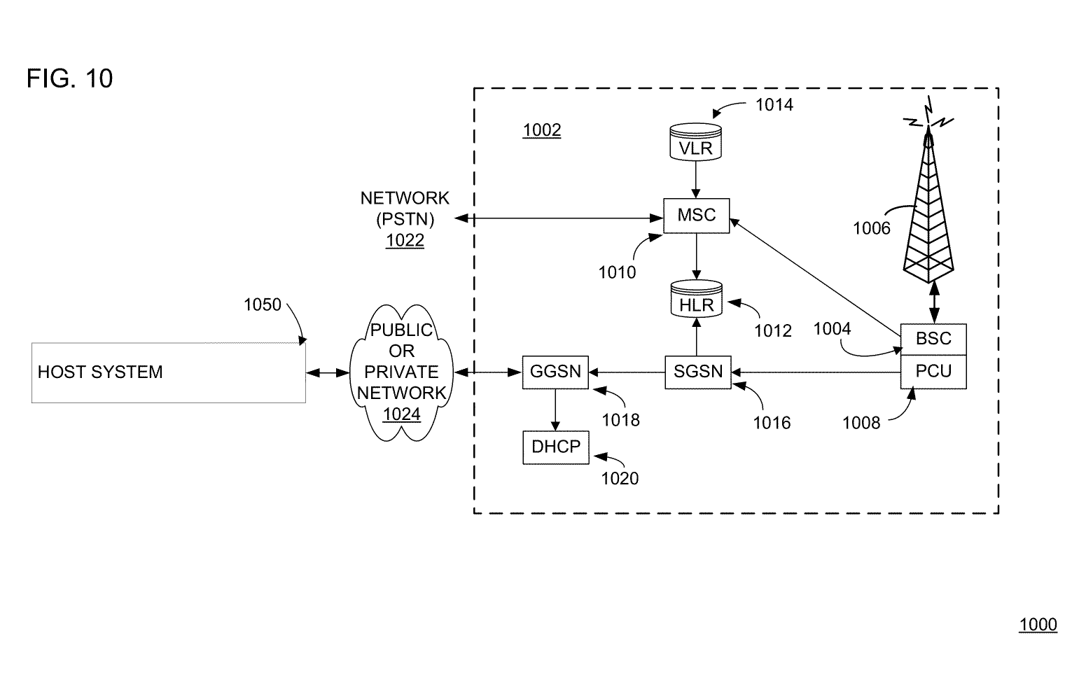

The handheld mobile device 800 also includes a connect module 844, and an IT policy module 846. The connect module 844 implements the communication protocols that are required for the handheld mobile device 800 to communicate with the wireless infrastructure and any host system, such as an enterprise system, with which the handheld mobile device 800 is authorized to interface. Examples of a wireless infrastructure and an enterprise system are given in FIG. 10, which is described in more detail below.

The connect module 844 includes a set of APIs that can be integrated with the handheld mobile device 800 to allow the handheld mobile device 800 to use any number of services associated with the enterprise system. The connect module 844 allows the handheld mobile device 800 to establish an end-to-end secure, authenticated communication pipe with the host system. A subset of applications for which access is provided by the connect module 844 can be used to pass IT policy commands from the host system to the handheld mobile device 800. This can be done in a wireless or wired manner. These instructions can then be passed to the IT policy module 846 to modify the configuration of the device 800. Alternatively, in some cases, the IT policy update can also be done over a wired connection.

The IT policy module 846 receives IT policy data that encodes the IT policy. The IT policy module 846 then ensures that the IT policy data is authenticated by the handheld mobile device 800. The IT policy data can then be stored in the flash memory 806 in its native form. After the IT policy data is stored, a global notification can be sent by the IT policy module 846 to all of the applications residing on the handheld mobile device 800. Applications for which the IT policy may be applicable then respond by reading the IT policy data to look for IT policy rules that are applicable.

The IT policy module 846 can include a parser 847, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 846 can determine which applications are affected by the IT policy data and transmit a notification to only those applications. In either of these cases, for applications that are not being executed by the main processor 802 at the time of the notification, the applications can call the parser or the IT policy module 846 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 846 sends an acknowledgement back to the host system to indicate that the IT policy data was received and successfully applied.

The handheld mobile device 800 also includes an impact avoidance module 848. The impact avoidance module 848 implements the functionality described in FIG. 1-???

Other types of software applications can also be installed on the handheld mobile device 800. These software applications can be third party applications, which are added after the manufacture of the handheld mobile device 800. Examples of third party applications include games, calculators, utilities, etc.

The additional applications can be loaded onto the handheld mobile device 800 through at least one of the wireless network 805, the auxiliary I/O subsystem 812, the data port 814, the short-range communications subsystem 822, or any other suitable device subsystem 824. This flexibility in application installation increases the functionality of the handheld mobile device 800 and may provide enhanced on-device functions, communication-related functions, or both. For example, secure communication applications may enable electronic commerce functions and other such financial transactions to be performed using the handheld mobile device 800.

In one implementation, the impact avoidance module 848 is an additional software application that is loaded onto the handheld mobile device 800.

The data port 814 enables a subscriber to set preferences through an external device or software application and extends the capabilities of the handheld mobile device 800 by providing for information or software downloads to the handheld mobile device 800 other than through a wireless communication network. The alternate download path may, for example, be used to load an encryption key onto the handheld mobile device 800 through a direct and thus reliable and trusted connection to provide secure device communication.

The data port 814 can be any suitable port that enables data communication between the handheld mobile device 800 and another computing device. The data port 814 can be a serial or a parallel port. In some instances, the data port 814 can be a USB port that includes data lines for data transfer and a supply line that can provide a charging current to charge the battery 830 of the handheld mobile device 800.

The short-range communications subsystem 822 provides for communication between the handheld mobile device 800 and different systems or devices, without the use of the wireless network 805. For example, the subsystem 822 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 804 and input to the main processor 802. The main processor 802 will then process the received signal for output to the display 810 or alternatively to the auxiliary I/O subsystem 812. A subscriber may also compose data items, such as e-mail messages, for example, using the keyboard 816 in conjunction with the display 810 and possibly the auxiliary I/O subsystem 812. The auxiliary subsystem 812 may include devices such as: a touch screen, mouse, track ball, infrared fingerprint detector, or a roller wheel with dynamic button pressing capability. The keyboard 816 is preferably an alphanumeric keyboard and/or telephone-type keypad. However, other types of keyboards may also be used. A composed item may be transmitted over the wireless network 805 through the communication subsystem 804.

For voice communications, the overall operation of the handheld mobile device 800 is substantially similar, except that the received signals are output to the speaker 818, and signals for transmission are generated by the microphone 820. Alternative voice or audio I/O subsystems, such as a voice message recording subsystem, can also be implemented on the handheld mobile device 800. Although voice or audio signal output is accomplished primarily through the speaker 818, the display 810 can also be used to provide additional information such as the identity of a calling party, duration of a voice call, or other voice call related information.

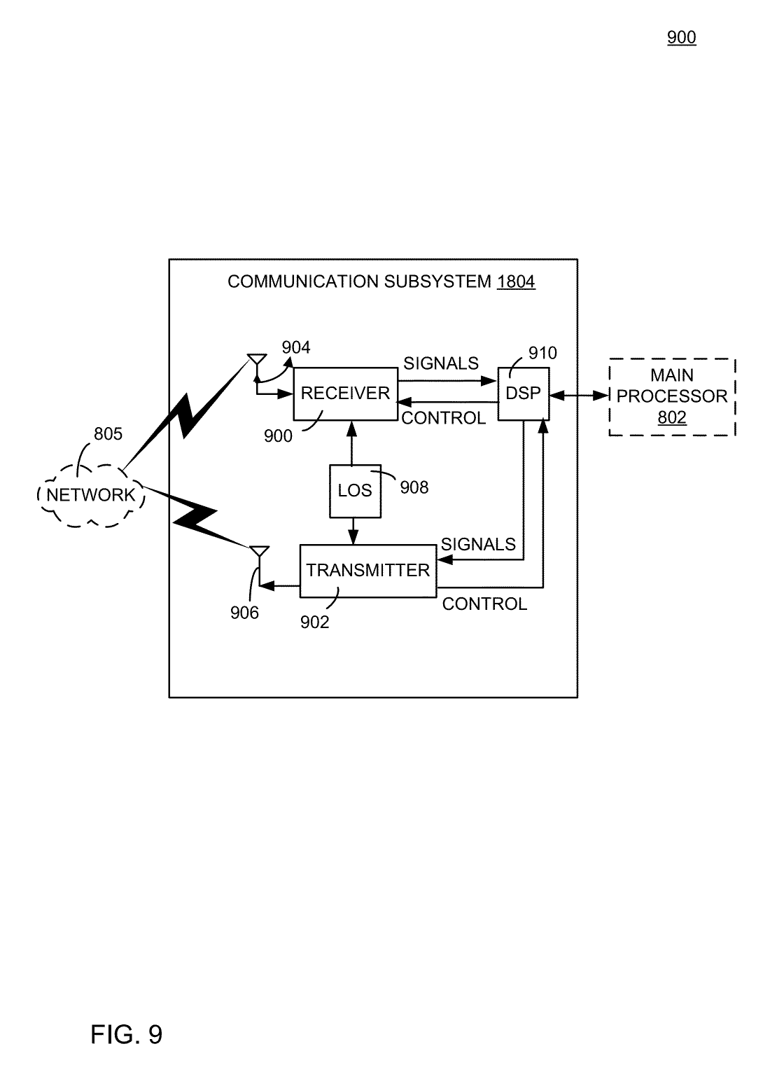

FIG. 9 is a block diagram of the communication subsystem component 804 is shown, according to an implementation. The communication subsystem 804 includes a receiver 900, a transmitter 902, as well as associated components such as one or more embedded or internal antenna elements 904 and 906, Local Oscillators (LOs) 908, and a processing module such as a Digital Signal Processor (DSP) 910. The particular implementation of the communication subsystem 804 is dependent upon the communication wireless network 805 with which the handheld mobile device 800 is intended to operate. Thus, it should be understood that the implementation illustrated in FIG. 9 serves only as one example.

Signals received by the antenna 904 through the wireless network 805 are input to the receiver 900, which may perform such common receiver functions as signal amplification, frequency down conversion, filtering, channel selection, and analog-to-digital (A/D) conversion. A/D conversion of a received signal allows more complex communication functions such as demodulation and decoding to be performed in the DSP 910. In a similar manner, signals to be transmitted are processed, including modulation and encoding, by the DSP 910. These DSP-processed signals are input to the transmitter 902 for digital-to-analog (D/A) conversion, frequency up conversion, filtering, amplification and transmission over the wireless network 805 via the antenna 906. The DSP 910 not only processes communication signals, but also provides for receiver and transmitter control. For example, the gains applied to communication signals in the receiver 900 and the transmitter 902 may be adaptively controlled through automatic gain control algorithms implemented in the DSP 910.

The wireless link between the handheld mobile device 800 and the wireless network 805 can contain one or more different channels, typically different RF channels, and associated protocols used between the handheld mobile device 800 and the wireless network 805. An RF channel is a limited resource that must be conserved, typically due to limits in overall bandwidth and limited battery power of the handheld mobile device 800.

When the handheld mobile device 800 is fully operational, the transmitter 902 is typically keyed or turned on only when it is transmitting to the wireless network 805 and is otherwise turned off to conserve resources. Similarly, the receiver 900 is periodically turned off to conserve power until the receiver 900 is needed to receive signals or information (if at all) during designated time periods.

FIG. 10 is a block diagram of an exemplary implementation of a node 1002 of the wireless network 805. In practice, the wireless network 805 comprises one or more nodes 1002. In conjunction with the connect module 844, the handheld mobile device 800 can communicate with the node 1002 within the wireless network 805. In the exemplary implementation of FIG. 10, the node 1002 is configured in accordance with General Packet Radio Service (GPRS) and Global Systems for Mobile (GSM) technologies. The node 1002 includes a base station controller (BSC) 1004 with an associated tower station 1006, a Packet Control Unit (PCU) 1008 added for GPRS support in GSM, a Mobile Switching Center (MSC) 1010, a Home Location Register (HLR) 1012, a Visitor Location Registry (VLR) 1014, a Serving GPRS Support Node (SGSN) 1016, a Gateway GPRS Support Node (GGSN) 1018, and a Dynamic Host Configuration Protocol (DHCP) 1020. This list of components is not meant to be an exhaustive list of the components of every node 1002 within a GSM/GPRS network, but rather a list of components that are commonly used in communications through the wireless network 805.

In a GSM network, the MSC 1010 is coupled to the BSC 1004 and to a landline network, such as a Public Switched Telephone Network (PSTN) 1022 to satisfy circuit switched requirements. The connection through the PCU 1008, the SGSN 1016 and the GGSN 1018 to a public or private network (Internet) 1024 (also referred to herein generally as a shared network infrastructure) represents the data path for GPRS capable mobile devices. In a GSM network extended with GPRS capabilities, the BSC 1004 also contains the Packet Control Unit (PCU) 1008 that connects to the SGSN 1016 to control segmentation, radio channel allocation and to satisfy packet switched requirements. To track the location of the handheld mobile device 800 and availability for both circuit switched and packet switched management, the HLR 1012 is shared between the MSC 1010 and the SGSN 1016. Access to the VLR 1014 is controlled by the MSC 1010.

The tower station 1006 is a fixed transceiver station and together with the BSC 1004 form fixed transceiver equipment. The fixed transceiver equipment provides wireless network coverage for a particular coverage area commonly referred to as a “cell”. The fixed transceiver equipment transmits communication signals to and receives communication signals from mobile devices within its cell via the tower station 1006. The fixed transceiver equipment normally performs such functions as modulation and possibly encoding and/or encryption of signals to be transmitted to the handheld mobile device 800 in accordance with particular, usually predetermined, communication protocols and parameters, under control of its controller. The fixed transceiver equipment similarly demodulates and possibly decodes and decrypts, if necessary, any communication signals received from the handheld mobile device 800 within its cell. Communication protocols and parameters may vary between different nodes. For example, one node may employ a different modulation scheme and operate at different frequencies than other nodes.

For all mobile devices 800 registered with a specific network, permanent configuration data such as a user profile is stored in the HLR 1012. The HLR 1012 also contains location information for each registered mobile device and can be queried to determine the current location of a mobile device. The MSC 1010 is responsible for a group of location areas and stores the data of the mobile devices currently in its area of responsibility in the VLR 1014. Further, the VLR 1014 also contains information on mobile devices that are visiting other networks. The information in the VLR 1014 includes part of the permanent mobile device data transmitted from the HLR 1012 to the VLR 1014 for faster access. By moving additional information from a remote HLR 1012 node to the VLR 1014, the amount of traffic between these nodes can be reduced so that voice and data services can be provided with faster response times and at the same time requiring less use of computing resources.

The SGSN 1016 and the GGSN 1018 are elements added for GPRS support; namely packet switched data support, within GSM. The SGSN 1016 and the MSC 1010 have similar responsibilities within the wireless network 805 by keeping track of the location of each handheld mobile device 800. The SGSN 1016 also performs security functions and access control for data traffic on the wireless network 805. The GGSN 1018 provides internetworking connections with external packet switched networks and connects to one or more SGSN's 1016 via an Internet Protocol (IP) backbone network operated within the wireless network 805. During normal operations, a given handheld mobile device 800 must perform a “GPRS Attach” to acquire an IP address and to access data services. This requirement is not present in circuit switched voice channels as Integrated Services Digital Network (ISDN) addresses are used for routing incoming and outgoing calls. Currently, all GPRS capable networks use private, dynamically assigned IP addresses, thus requiring the DHCP server 1020 connected to the GGSN 1018. There are many mechanisms for dynamic IP assignment, including using a combination of a Remote Authentication Dial-In User Service (Radius) server and a DHCP server. Once the GPRS Attach is complete, a logical connection is established from a handheld mobile device 800, through the PCU 1008, and the SGSN 1016 to an Access Point Node (APN) within the GGSN 1018. The APN represents a logical end of an IP tunnel that can either access direct Internet compatible services or private network connections. The APN also represents a security mechanism for the wireless network 805, insofar as each handheld mobile device 800 must be assigned to one or more APNs and mobile devices 800 cannot exchange data without first performing a GPRS Attach to an APN that it has been authorized to use. The APN may be considered to be similar to an Internet domain name such as “myconnection.wireless.com”.

Once the GPRS Attach operation is complete, a tunnel is created and all traffic is exchanged within standard IP packets using any protocol that can be supported in IP packets. This includes tunneling methods such as IP over IP as in the case with some IPSecurity (IPsec) connections used with Virtual Private Networks (VPN). These tunnels are also referred to as Packet Data Protocol (PDP) Contexts and there are a limited number of these available in the wireless network 805. To maximize use of the PDP Contexts, the wireless network 805 will execute an idle timer for each PDP Context to determine if there is a lack of activity. When a handheld mobile device 800 is not using its PDP Context, the PDP Context can be de-allocated and the IP address returned to the IP address pool managed by the DHCP server 1020.

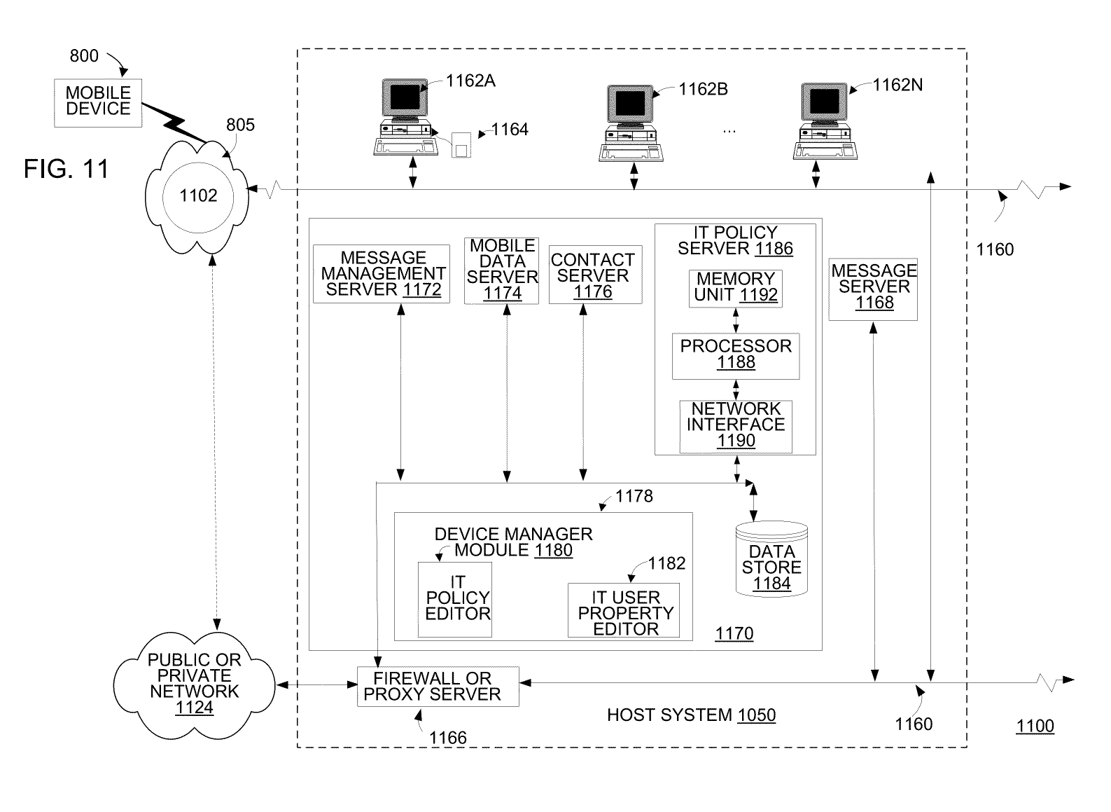

Referring now to FIG. 11, shown therein is a block diagram illustrating components of an exemplary configuration of a host system 1050 that the handheld mobile device 800 can communicate with in conjunction with the connect module 844. The host system 1050 will typically be a corporate enterprise or other local area network (LAN), but may also be a home office computer or some other private system, for example, in variant implementations. In this example shown in FIG. 11, the host system 1150 is depicted as a LAN of an organization to which a user of the handheld mobile device 800 belongs. Typically, a plurality of mobile devices can communicate wirelessly with the host system 1050 through one or more nodes 902 of the wireless network 805.

The host system 1050 comprises a number of network components connected to each other by a network 1160. For instance, a user's desktop computer 1162a with an accompanying cradle 1164 for the user's handheld mobile device 800 is situated on a LAN connection. The cradle 1164 for the handheld mobile device 800 can be coupled to the computer 1162a by a serial or a Universal Serial Bus (USB) connection, for example. Other user computers 1162b-1162n are also situated on the network 1160, and each may or may not be equipped with an accompanying cradle 1164. The cradle 1164 facilitates the loading of information (e.g. PIM data, private symmetric encryption keys to facilitate secure communications) from the user computer 1162a to the handheld mobile device 800, and may be particularly useful for bulk information updates often performed in initializing the handheld mobile device 800 for use. The information downloaded to the handheld mobile device 800 may include certificates used in the exchange of messages.

It will be understood by persons skilled in the art that the user computers 1162a-1162n will typically also be connected to other peripheral devices, such as printers, etc. which are not explicitly shown in FIG. 11. Furthermore, only a subset of network components of the host system 1050 are shown in FIG. 11 for ease of exposition, and it will be understood by persons skilled in the art that the host system 1050 will comprise additional components that are not explicitly shown in FIG. 11 for this exemplary configuration. More generally, the host system 1050 may represent a smaller part of a larger network (not shown) of the organization, and may comprise different components and/or be arranged in different topologies than that shown in the exemplary implementation of FIG. 11.

To facilitate the operation of the handheld mobile device 800 and the wireless communication of messages and message-related data between the handheld mobile device 800 and components of the host system 1050, a number of wireless communication support components 1170 can be provided. In some implementations, the wireless communication support components 1170 can include a message management server 1172, a mobile data server 1174, a contact server 1176, and a device manager module 1178. The device manager module 1178 includes an IT Policy editor 1180 and an IT user property editor 1182, as well as other software components for allowing an IT administrator to configure the mobile devices 800. In an alternative implementation, there may be one editor that provides the functionality of both the IT policy editor 1180 and the IT user property editor 1182. The support components 1170 also include a data store 1184, and an IT policy server 1186. The IT policy server 1186 includes a processor 1188, a network interface 1190 and a memory unit 1192. The processor 1188 controls the operation of the IT policy server 1186 and executes functions related to the standardized IT policy as described below. The network interface 1190 allows the IT policy server 1186 to communicate with the various components of the host system 1050 and the mobile devices 800. The memory unit 1192 can store functions used in implementing the IT policy as well as related data. Those skilled in the art know how to implement these various components. Other components may also be included as is well known to those skilled in the art. Further, in some implementations, the data store 1184 can be part of any one of the servers.

In this exemplary implementation, the handheld mobile device 800 communicates with the host system 1050 through node 902 of the wireless network 805 and a shared network infrastructure 1124 such as a service provider network or the public Internet. Access to the host system 1050 may be provided through one or more routers (not shown), and computing devices of the host system 1050 may operate from behind a firewall or proxy server 1166. The proxy server 1166 provides a secure node and a wireless internet gateway for the host system 1050. The proxy server 1166 intelligently routes data to the correct destination server within the host system 1050.

In some implementations, the host system 1050 can include a wireless VPN router (not shown) to facilitate data exchange between the host system 1050 and the handheld mobile device 800. The wireless VPN router allows a VPN connection to be established directly through a specific wireless network to the handheld mobile device 800. The wireless VPN router can be used with the Internet Protocol (IP) Version 8 (IPV6) and IP-based wireless networks. This protocol can provide enough IP addresses so that each mobile device has a dedicated IP address, making it possible to push information to a mobile device at any time. An advantage of using a wireless VPN router is that it can be an off-the-shelf VPN component, and does not require a separate wireless gateway and separate wireless infrastructure. A VPN connection can preferably be a Transmission Control Protocol (TCP)/IP or User Datagram Protocol (UDP)/IP connection for delivering the messages directly to the handheld mobile device 800 in this alternative implementation.

Messages intended for a user of the handheld mobile device 800 are initially received by a message server 1168 of the host system 1050. Such messages may originate from any number of sources. For instance, a message may have been sent by a sender from the computer 1162b within the host system 1050, from a different mobile device (not shown) connected to the wireless network 805 or a different wireless network, or from a different computing device, or other device capable of transmitting messages, via the shared network infrastructure 1124, possibly through an application service provider (ASP) or Internet service provider (ISP), for example.

The message server 1168 typically acts as the primary interface for the exchange of messages, particularly e-mail messages, within the organization and over the shared network infrastructure 1124. Each user in the organization that has been set up to transmit and receive messages is typically associated with a user account managed by the message server 1168. Some exemplary implementations of the message server 1168 include a Microsoft Exchange™ server, a Lotus Domino™ server, a Novell Groupwise™ server, or another suitable mail server installed in a corporate environment. In some implementations, the host system 1050 may comprise multiple message servers 1168. The message server 1168 may also be adapted to provide additional functions beyond message management, including the management of data associated with calendars and task lists, for example.

When messages are received by the message server 1168, they are typically stored in a data store associated with the message server 1168. In one or more implementations, the data store may be a separate hardware unit, such as data store 1184, with which the message server 1168 communicates. Messages can be subsequently retrieved and delivered to users by accessing the message server 1168. For instance, an e-mail client application operating on a user's computer 1162a may request the e-mail messages associated with that user's account stored on the data store associated with the message server 1168. These messages are then retrieved from the data store and stored locally on the computer 1162a. The data store associated with the message server 1168 can store copies of each message that is locally stored on the handheld mobile device 800. Alternatively, the data store associated with the message server 1168 can store all of the messages for the user of the handheld mobile device 800 and only a smaller number of messages can be stored on the handheld mobile device 800 to conserve memory. For instance, the most recent messages (i.e. those received in the past two to three months for example) can be stored on the handheld mobile device 800.

When operating the handheld mobile device 800, the user may wish to have e-mail messages retrieved for delivery to the handheld mobile device 800. The message application 838 operating on the handheld mobile device 800 may also request messages associated with the user's account from the message server 1168. The message application 838 may be configured (either by the user or by an administrator, possibly in accordance with an organization's information technology (IT) policy) to make this request at the direction of the user, at some pre-defined time interval, or upon the occurrence of some pre-defined event. In some implementations, the handheld mobile device 800 is assigned its own e-mail address, and messages addressed specifically to the handheld mobile device 800 are automatically redirected to the handheld mobile device 800 as they are received by the message server 1168.

The message management server 1172 can be used to specifically provide support for the management of messages, such as e-mail messages, that are to be handled by mobile devices. Generally, while messages are still stored on the message server 1168, the message management server 1172 can be used to control when, if, and how messages are sent to the handheld mobile device 800. The message management server 1172 also facilitates the handling of messages composed on the handheld mobile device 800, which are sent to the message server 1168 for subsequent delivery.

For example, the message management server 1172 may monitor the user's “mailbox” (e.g. the message store associated with the user's account on the message server 1168) for new e-mail messages, and apply user-definable filters to new messages to determine if and how the messages are relayed to the user's handheld mobile device 800. The message management server 1172 may also compress and encrypt new messages (e.g. using an encryption technique such as Data Encryption Standard (DES), Triple DES, or Advanced Encryption Standard (AES)) and push the compressed and encrypted messages to the 006Dobile device 800 via the shared network infrastructure 1124 and the wireless network 805. The message management server 1172 may also receive messages composed on the handheld mobile device 800 (e.g. encrypted using Triple DES), decrypt and decompress the composed messages, re-format the composed messages if desired so that they will appear to have originated from the user's computer 1162a, and re-route the composed messages to the message server 1168 for delivery.

Certain properties or restrictions associated with messages that are to be sent from and/or received by the handheld mobile device 800 can be defined (e.g. by an administrator in accordance with IT policy) and enforced by the message management server 1172. These may include whether the handheld mobile device 800 may receive encrypted and/or signed messages, minimum encryption key sizes, whether outgoing messages must be encrypted and/or signed, and whether copies of all secure messages sent from the handheld mobile device 800 are to be sent to a pre-defined copy address, for example.

The message management server 1172 may also be adapted to provide other control functions, such as only pushing certain message information or pre-defined portions (e.g. “blocks”) of a message stored on the message server 1168 to the handheld mobile device 800. For example, in some cases, when a message is initially retrieved by the handheld mobile device 800 from the message server 1168, the message management server 1172 may push only the first part of a message to the handheld mobile device 800, with the part being of a pre-defined size (e.g. 2 KB). The user can then request that more of the message be delivered in similar-sized blocks by the message management server 1172 to the handheld mobile device 800, possibly up to a maximum pre-defined message size. Accordingly, the message management server 1172 facilitates better control over the type of data and the amount of data that is communicated to the handheld mobile device 800, and can help to minimize potential waste of bandwidth or other resources.

The mobile data server 1174 encompasses any other server that stores information that is relevant to the corporation. The mobile data server 1174 may include, but is not limited to, databases, online data document repositories, customer relationship management (CRM) systems, or enterprise resource planning (ERP) applications.

The contact server 1176 can provide information for a list of contacts for the user in a similar fashion as the address book on the handheld mobile device 800. Accordingly, for a given contact, the contact server 1176 can include the name, phone number, work address and e-mail address of the contact, among other information. The contact server 1176 can also provide a global address list that contains the contact information for all of the contacts associated with the host system 1050.

It will be understood by persons skilled in the art that the message management server 1172, the mobile data server 1174, the contact server 1176, the device manager module 1178, the data store 1184 and the IT policy server 1186 do not need to be implemented on separate physical servers within the host system 1050. For example, some or all of the functions associated with the message management server 1172 may be integrated with the message server 1168, or some other server in the host system 1050. Alternatively, the host system 1050 may comprise multiple message management servers 1172, particularly in variant implementations where a large number of mobile devices need to be supported.

Alternatively, in some implementations, the IT policy server 1186 can provide the IT policy editor 1180, the IT user property editor 1182 and the data store 1184. In some cases, the IT policy server 1186 can also provide the device manager module 1178. The processor 1188 of the IT policy server 1186 can be used to perform the various steps of a method for providing IT policy data that is customizable on a per-user basis as explained further below and in conjunction with FIGS. 9 to 13. The processor 1188 can execute the editors 1180 and 1182. In some cases, the functionality of the editors 1180 and 1182 can be provided by a single editor. In some cases, the memory unit 1192 can provide the data store 1184.

The device manager module 1178 provides an IT administrator with a graphical user interface with which the IT administrator interacts to configure various settings for the mobile devices 800. As mentioned, the IT administrator can use IT policy rules to define behaviors of certain applications on the handheld mobile device 800 that are permitted such as phone, web browser or Instant Messenger use. The IT policy rules can also be used to set specific values for configuration settings that an organization requires on the mobile devices 800 such as auto signature text, WLAN/VoIP/VPN configuration, security requirements (e.g. encryption algorithms, password rules, etc.), specifying themes or applications that are allowed to execute on the handheld mobile device 800, and the like.

The computation resource 2302 typically includes at least some form of computer-readable media. Computer-readable media can be any available media that can be accessed by the computation resource 2302. By way of example, and not limitation, computer-readable media can comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 2302.

Communication media typically embodies computer-readable instructions, data structures, program modules.

By way of example, and not limitation, communication media include wired media, such as wired network or direct-wired connections, and wireless media, such as acoustic, RF, infrared and other wireless media. The scope of the term computer-readable media includes combinations of any of the above.

More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI).

### CONCLUSION

A handheld impact notification and avoidance system is described. A technical effect of the handheld impact notification and avoidance system is output of notification and possible evasive action in response to predicted impact. Although specific implementations have been illustrated and described herein, it will be appreciated by those of ordinary skill in the art that any arrangement which is calculated to achieve the same purpose may be substituted for the specific implementations shown. This disclosure is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future cellular telephones, tablets, and notebook computers, different file systems, and new data types.

The terminology used in this application is meant to include all wireless mobile devices and communication environments and alternate technologies which provide the same functionality as described herein.

1. A method of a handheld mobile device, the method comprising:
receiving internal motion data that represents a direction and a speed of the handheld mobile device;
receiving external motion data that represents a direction and a speed of an external object;
determining a relative motion of the handheld mobile device and the external object from the data that represents the direction and the speed of the handheld mobile device and the data that represents the direction and the speed of external object;
determining a risk of an impact between the handheld mobile device and the external object in an immediate vicinity from the relative motion of the handheld mobile device and the external object; and
changing output of the handheld device when the risk of the impact between the handheld mobile device and the external object in the immediate vicinity is greater than a predetermined threshold.

2. The method of claim 1 further comprising:
the receiving occurs about simultaneous to each other.

3. The method of claim 1 further comprising:
the receiving are real-time data gathering operations.

4. The method of claim 1 wherein changing the output of the handheld mobile device further comprises:
blanking a screen of the handheld mobile device.

5. The method of claim 4, wherein the external motion data that represents the direction and the speed of the external object further comprises:
external motion data that represents the direction and the speed of external object along a horizontal plane of the handheld mobile device.

6. The method of claim 1 wherein the external motion data that represents the direction and the speed of the external object further comprises:
external motion data that represents the direction and the speed of the external object in a plane that is parallel to a terrain in the vicinity of the handheld mobile device.

7. A handheld mobile device comprising:
a determiner of a relative motion of the handheld mobile device and an external object from data that represents a direction and a speed of the handheld mobile device and from data that represents a direction and a speed of the external object;
a receiver of internal motion data that represents the direction and the speed of the handheld mobile device, the receiver being operably coupled to the determiner;
a receiver of external motion data that represents the direction and the speed of the external object, the receiver being operably coupled to the determiner;
a determiner of a risk of an impact between the handheld mobile device and an object in an immediate vicinity from the relative motion of the handheld mobile device and the external object; and
a changer of output of the handheld device when the risk of the impact between the handheld mobile device and the external object in the immediate vicinity is greater than a predetermined threshold.

8. The handheld mobile device of claim 7 wherein the receiver of the external motion data further comprises:
an optical sensor.

9. The handheld mobile device of claim 7, wherein the receiver of the external motion data further comprises:
an infrared sensor.

10. The handheld mobile device of claim 7, wherein the receiver of the external motion data further comprises:
an ultrasonic sensor.

11. The handheld mobile device of claim 7, wherein the receiver of the external motion data further comprises:
a RF sensor.

12. The handheld mobile device of claim 7 wherein the receiver of the internal motion data further comprises:
a GPS tracking device.

13. An apparatus in a handheld mobile device, the apparatus comprising:
a determiner of a relative motion of the handheld mobile device and an external object from data that represents a direction and a speed of the handheld mobile device and from data that represents a direction and a speed of the external object;
a receiver of internal motion data that represents the direction and the speed of the handheld mobile device, the receiver being operably coupled to the determiner;
a receiver of external motion data that represents the direction of the external object and the speed of the external object, the receiver being operably coupled to the determiner;
a determiner of a risk of an impact between the handheld mobile device and the external object in an immediate vicinity from the relative motion of the handheld mobile device and the external object; and
a changer of output of the handheld device when the risk of the impact between the handheld mobile device and the external object in the immediate vicinity is greater than a predetermined threshold.

14. The apparatus of claim 13, further comprising:
a blanker of a screen of the handheld mobile device.

15. The apparatus of claim 13, wherein the receiver of the internal motion data further comprises:
an accelerometer.

16. The apparatus of claim 13, wherein the receiver of the internal motion data further comprises:
a gyroscope.

17. The apparatus of claim 13, wherein the receiver of the internal motion data further comprises:
a barometric pressure sensor.

18. The apparatus of claim 13 wherein the receiver of the internal motion data further comprises:
a GPS tracking device.
